(19) United States
(12) Patent Application Publication
(10) Pub. No.: US 2006/0075224 A1
(43) Pub. Date: Apr. 6, 2006

(54) System for activating multiple applications for concurrent operation

(76) Inventor: David Tao, West Chester, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/235,406

(22) Filed: Sep. 26, 2005

Related U.S. Application Data
(60) Provisional application No. 60/612,970, filed on Sep. 24, 2004.

(51) Int. Cl. H04L 9/00

(52) U.S. Cl. 713/164

(57) ABSTRACT

A single sign-on system enables a user to access multiple, disparate executable applications for concurrent operation in the system. The system includes a data source, an interface processor, and an authentication processor. The data source provides configuration data for multiple executable applications. The configuration data identifies an individual executable application and a launching process for the individual executable application. The interface processor receives user credential information, including a user identifier, in response to user initiation of a first executable application of the multiple executable applications. The authentication processor authenticates a user authorized to access a second executable application of the multiple executable applications, in response to receiving the configuration data and the user credential information. The authentication processor initiates execution of the second executable application, in response to receiving a user command to activate the second executable application for a first time during a user session of computer operation.

### CROSS-REFERENCE TO RELATED APPLICATIONS

The present application is a non-provisional application of provisional application having Ser. No. 60/612,970 filed by David Tao on Sep. 24, 2004.

### FIELD OF THE INVENTION

The present invention generally relates to computer systems. More particularly, the present invention relates to a system for activating multiple executable applications for concurrent operation.

### BACKGROUND OF THE INVENTION

Computer security is a field of computer science concerned with the control of risks related to use of computer systems. In computer security, authentication is a process of determining whether a computer, a software application, or a user is, in fact, what or who it is declared to be.

An example of user authentication is a user credential, such as a user name and password. Requirements for user credentials may be different among multiple software applications, which complicate a user's access to multiple software applications during the same work session. For example, healthcare workers may use healthcare-related applications, such as clinical results reporting, physician order entry, and chart completion, and may use general-purpose software applications, such as e-mail, time and attendance, accounting, human resources self-service, and incident reporting.

Single sign-on (SSO) is a specialized form of software authentication that enables a computer, a computer program, or a user to authenticate once, and gain access to multiple software applications and/or multiple computer systems. For example, in a client/server environment, SSO is a session/user authentication process that permits a user to enter one name and one password in order to access multiple software applications. The SSO, which is requested at the initiation of the session, authenticates the user to access the software applications on the server that have been given access rights, and eliminates future authentication prompts when the user switches between software applications during a particular session. Examples of SSO or reduced signon systems include: enterprise single sign-on (E-SSO), web single sign-on (Web-SSO), Kerberos, Federation, and OpenID.

E-SSO, also called legacy single sign-on, after primary user authentication, intercepts logon prompts presented by secondary applications, and automatically fills in fields such as a logon ID or password. E-SSO systems allow for interoperability with software applications that are unable to externalize user authentication, essentially through “screen scraping.” However, E-SSO requires cooperation among computers in the enterprise, and is sometimes referred to as enterprise reduced sign-on.

Web-SSO, also called web access management (Web-AM), works strictly with applications and resources accessed with a web browser. Access to web resources is intercepted, either using a web proxy server or by installing a component on each targeted web server. Unauthenticated users who attempt to access a resource are diverted to an authentication service, and returned after a successful sign-on. Cookies are typically used to track user authentication state, and the Web-SSO infrastructure extracts user identification information from these cookies, passing it into each web resource. However, Web-SSO does not work with non-web based applications and resources that are not accessed with a web browser.

Kerberos is a popular mechanism for applications to externalize authentication entirely. Users sign into the Kerberos server, and are issued a ticket, which their client software presents to servers that they attempt to access. Kerberos is available on Unix, Windows, and mainframe platforms. However, Kerberos requires modification of client/server software application code, and is consequently not used by many legacy (i.e., older) applications.

Federation is a new approach, also for web applications, which uses standards-based protocols to enable one application to assert the identity of a user to another, thereby avoiding the need for redundant authentication. Standards to support Federation include security assertion markup language (SAML) and web services security (WS-Security). However, Federation requires modification of the web application code, and is consequently not used by many legacy (i.e., older) applications or by non-web based applications.

OpenID is a distributed and decentralized SSO process, where identity is tied to an easily-processed universal resource locator (URL), which can be verified by any server using the protocol. On OpenID-enabled sites, Internet users don't need to create and manage a new account for every site before being granted access. Instead, one authentication with a trusted site that supports OpenID is necessary. The trusted site provides a declaration of the user's identity to other OpenID-enabled sites. Since OpenID does not rely on a separate trust mechanism, OpenID is not meant to be used on sensitive accounts (e.g., banking and on-line purchasing).

Health Level 7 (HL7) is an international standard for data exchange between computer systems in the healthcare field. Clinical Context Object Workgroup (CCOW) is a standards committee within the HL7 group that developed a CCOW part of the HL7 standard. The CCOW part of the HL7 standard is vendor independent and allows clinical applications to share information at the point of care. Using a technique called “context management,” CCOW provides a user with a unified view on the information held in separate and disparate healthcare applications referring to the same patient, encounter or user. This means that when a user signs on to one application within the group of disparate applications tied together by the CCOW environment (i.e., CCOW-compliant applications), that same sign-on is simultaneously executed on other applications within the group using CCOW's “user mapper” facility. However, HL7 CCOW requires CCOW-compliant healthcare applications, which represents a portion of installed healthcare applications, and does not work with general-purpose applications that are not CCOW-compliant.

U.S. Pat. No. 5,774,551 discloses a system and method that provides transparent access from any system entry service to multiple account management services, and particularly to multiple authentication services on a computer system, thereby supporting unified logon and logoff. The system and method automatically initiates access to a predetermined group of applications following successful logon to a first application. However, a user cannot initiate subsequent access to a second application that is not originally initiated following logon to a first application, without a new logon being required. Further, the system and method provides access from any system entry service, but not from anywhere else.

Accordingly, there is a need for a system for activating multiple executable applications for concurrent operation that overcomes these and other disadvantages of the prior systems.

### SUMMARY OF THE INVENTION

A system enables a user to access multiple executable applications using a single sign-on service that authenticates information received from the user and a data source. The system includes a data source, an interface processor, and an authentication processor. The data source provides configuration data for multiple executable applications. The configuration data identifies an individual executable application and a launching process for the individual executable application. The interface processor receives user credential information, including a user identifier, in response to user initiation of a first executable application of the multiple executable applications. The authentication processor authenticates a user authorized to access a second executable application of the multiple executable applications, in response to receiving the configuration data and the user credential information. The authentication processor initiates execution of the second executable application, in response to receiving a user command to activate the second executable application for a first time during a user session of computer operation.

### BRIEF DESCRIPTION OF THE DRAWINGS

FIG. 1 illustrates a system for activating multiple executable applications for concurrent operation, in accordance with invention principles.

FIG. 2 illustrates client-server architecture for the system, as shown in FIG. 1, in accordance with invention principles.

FIG. 3 illustrates a method for the system, as shown in FIG. 1, in accordance with invention principles.

### DETAILED DESCRIPTION OF THE PREFERRED EMBODIMENTS

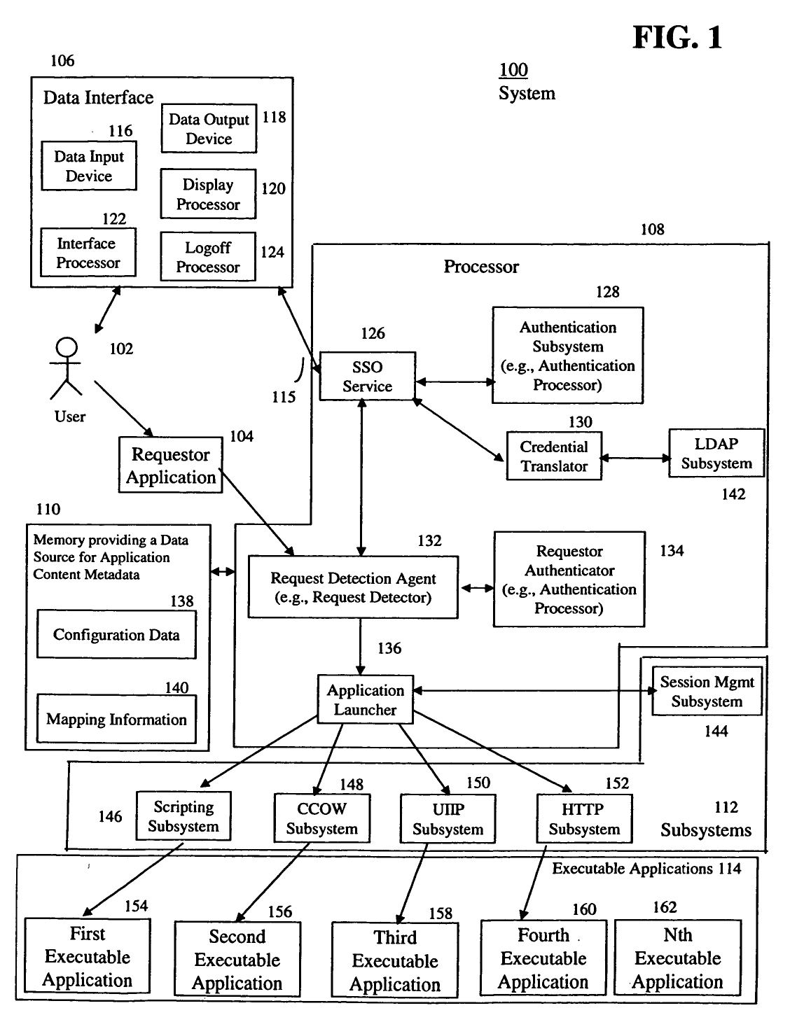

FIG. 1 illustrates a system 100 for activating multiple executable applications for concurrent operation (“system”). A user 102 or a requestor application 104 interacts with the system 100.

The user is a person that interacts with the system 100, either directly or through the requestor application 104. The user 102 may perform any role in an organization that implements the system 100. The user 102 registers with the system 100, and thereafter signs on (i.e., logs on) to the system 100 by providing to the system 100 user credential information (e.g., user name and password) associated with the user 102.

The requestor application 104 is any executable application (i.e., software application) that interacts with the system 100. The requestor application 104 may act independently or in cooperation with the user 102. The requestor application 104 may reside with the system 100 or remote from the system 100. When remote from the system 100, the requestor application 104 sends a message providing a universal resource locator (URL) containing its own application identifier and its own user identifier to the system 100.

The system 100 overcomes the disadvantages of the prior systems by providing two levels of authentication. At the first level of authentication, the system 100 authenticates the user credential information (e.g., user name and password) associated with a registered user 102 when the registered user 102 initially signs on to the system 100. At the second level of authentication, the system 100 authenticates application credential information (e.g., application identifier and password) associated with the user 102 and provided by the requester application 104 when the system 100 accesses the requester application 104. Therefore, the system 100 permits the user 102 to sign on to the system 100 a single time to activate at different times multiple, different, executable applications for concurrent operation on the system 100.

The system 100 advantageously provides web-based services to allow a requesting application 104 to launch any other application or web link, and to provide single sign-on (SSO) and contextual navigation into the other applications (otherwise called target applications), based on previously stored credentials and application-specific navigation data, without requiring the requestor to enter those credentials or navigation commands. The system 100 can be used either via a portal user interface (UI), or via a request from any authenticated requestor that can submit a Hypertext Transmission Protocol (HTTP) Universal Resource Locator (URL) request (this can include even non-web-based applications).

The system 100 includes a data interface 106, a processor 108, a memory device 110, subsystems 112, and executable applications 114, each being interconnected by a communication path 115, as referenced, for example, between the user interface 106 the processor 108.

The data interface 106 further includes a data input device 116, a data output device 118, a display processor 120, an interface processor 122, and a logoff processor 124.

The processor 108 further includes a SSO service 126, an authentication subsystem 128, a credential translator 130, a request detection agent 132, a requestor authenticator 134, an application launcher 136, and a IDAP subsystem 142.

The memory device 110 further includes application content metadata including configuration data 138 and mapping information 140.

The subsystems 112 further include a session management subsystem 144, a scripting subsystem 146, a CCOW subsystem 148, a UIIP (User Interface Interoperability Protocol) subsystem 150, a HTTP (Hypertext Transmission Protocol) subsystem 152. The subsystems 112 are delegated responsibilities by the application launcher 136.

CCOW is explained hereinabove in the background section.

UIIP enables web applications to be integrated into any workflow capable of supporting a browser. UIIP specifies the rules for passing URL data (including but not limited to encrypted identifiers for user and patient context), and introduces a centralized session manager to coordinate user inactivity timeouts, with the end result that independent UIIP-compliant applications can be integrated together into a user interface as if they were a single application. UIIP enables single sign-on, coordinated “keep alive” among the applications, and single sign-off and timeout.

HTTP is the primary method used to convey information on the World Wide Web. HTTP is a request/response protocol between a client, such as a web browser, and a server.

The executable applications 114 further include a first executable application 154, a second executable application 156, a third executable application 158, a fourth executable application 160, and an Nth executable application 162.

The system 100 may be employed by any type of enterprise, organization, or department, such as, for example, providers of healthcare products and/or services responsible for servicing the health and/or welfare of people in its care. For example, the system 100 represents a hospital information system. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 100 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 100 and/or elements contained therein also may be implemented in a centralized or decentralized configuration. The system 100 may be implemented as a client-server, web-based, or stand-alone configuration. In the case of the client-server or web-based configurations, one or more of the executable applications 114 may be accessed remotely over a communication network.

The communication path 115 (otherwise called network, bus, link, connection, channel, etc.) represents any type of protocol or data format such as, for example, Transmission Control Protocol Internet Protocol (TCP/IP).

The system 100, elements, and/or processes contained therein may be implemented in hardware, software, or a combination of both, and may include one or more processors, such as processor 108. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

The data interface 106 permits bi-directional exchange of data between the system 100 and the user 102 of the system 100 or another electronic device, such as a computer, or an application, such as, the requestor application 104.

The data input device 116 typically provides data to a processor in response to receiving input data either manually from a user or automatically from an electronic device, such as a computer. For manual input, the data input device is a keyboard and a mouse, but also may be a touch screen, or a microphone with a voice recognition application, for example.

The data output device 118 typically provides data from a processor for use by a user or an electronic device or application. For output to a user, the data output device 118 is a display, such as, a computer monitor (screen), that generates one or more display images in response to receiving the display signals from the display processor 120, but also may be a speaker or a printer, for example.

The display processor 120 or generator includes electronic circuitry or software or a combination of both for generating display images or portions thereof. The data output device 118, implemented as a display, is coupled to the display processor 120 and displays the generated display images. The display images permit user interaction with the processor 108 or other device. The display processor 120 may be implemented in the data interface 106 and/or the processor 108.

The interface processor 122 is coupled to the data input device 116, and the data output device 118 and/or the display processor 120. The interface processor 122 receives information from the user 102 of the data input device 116, and provides information to the user 102 via the display processor 120 and/or the data output device 118. The interface processor 122 may be implemented in the data interface 106 and/or the processor 108.

Information received by the interface processor 122, for example, includes user credential information including a user identifier in response to the user 102 initiating (i.e., accessing, logging on) a first executable application 154 of the multiple executable applications 114. User credential information includes, for example, one or more of the following: a user name and/or a user password associated with the user identifier, a trust token, biometric information, secure device information (e.g., electronic, magnetic, radio frequency)

The logoff processor 124 is coupled to the data input device 116, and the data output device 118 and/or the display processor 120. The logoff processor 124 receives a message, instruction, or command initiated by the user 102 or the requester application 104 to close a particular executable application 154-162. In response to receiving the command, the logoff processor 124 uses the mapping information 140 to selectively close the particular executable application 154-162, and other executable applications 154-162 exclusively launched from the particular executable application. The logoff processor 124 advantageously provides a cascading or domino effect for closing one or more executable applications 114. The logoff processor 124 may be implemented in the data interface 106 and/or the processor 108.

The SSO service 126 provides a service interface between the data interface 106 and the sub-systems 112. The SSO service 126 is accessible, for example, via a Service-Oriented Architecture (SOA), which expresses a software architectural concept that defines the use of services to support the requirements of software users. In a SOA environment, nodes on a network make resources available to other participants in the network as independent services that the participants access in a standardized way.

SOA typically identifies the use of web services. A web service is a software system designed to support interoperable machine-to-machine interaction over a network. The web service has an interface that is described in a machine-compatible format, such as, for example, Web Services Description Language (WSDL) metadata and Simple Object Access Protocol (SOAP) messages. However, SOA may be implemented using any service-based technology.

The SOA advantageously permits requestor application 104 to invoke a web portal's ability to sign on to external executable applications 114, without requiring the user 102 to go directly through the web portal's data interface 106. The SOA uses the requester application's ability to construct a universal resource locator (URL) message and to send its own application identification information, without having to store “mappings” to application identification information associated with the other systems.

The authentication subsystem 128, otherwise called an authentication processor, authenticates the user to the SSO service 126 and/or web portal by authenticating the user credential information including the user identifier received from the user 102. The authentication subsystem 128 also enforces password strength and expiration policy. The password strength is enforced using rules that enhance security to access the system 100. Rules enforcing password strength include, for example, the password length, inclusion of upper and lower case characters, numbers, special characters, and whether or not an old password can be reused. The password expiration policy includes, for example, a future date and/or time when the password is no longer valid and needs to be reset for continued access to the system 100. The authentication subsystem 128 may also support password synchronization and/or user provisioning, as independent systems that are compatible with the system 100. The authentication subsystem 128 may be implemented separately from or integrally with the requestor authenticator 134.

The credential translator 130 accesses and manages a repository of encrypted user credential information that permits a user 102 to access one or more of the executable applications 114. The user 102 or a system administrator enters the user credential information. The credential translator 130 is invoked when a user 102 starts the SSO service 126. The credential translator 130 includes an administration utility to create, modify, and delete user credential information. The administration utility disallows duplicate user identifiers for the same executable application 114. The credential translator 130 provides an interface (e.g., via extensible markup language (XML)) for updates that may be driven by an external source such as a provisioning tool. The credential translator 130 provides an interface that complies with the HL7 User Mapping specification, thereby allowing the credential translator 130 to be a single repository that advantageously satisfies both CCOW and non-CCOW requests.

For example, the credential translator 130 converts user credential information, received from the user 102 via the interface processor 122, to be compatible with credential information required to access the second executable application 156, for example, from the configuration data 138. The authentication subsystem 128 uses the converted user credential information to authenticate that the user 102 is authorized to access the second executable application 156.

In another example, the credential translator 130 associates user credential information, received from the user 102 via the interface processor 122, to be compatible with credential information required to access the second executable application 156, for example, from the configuration data 138. The authentication subsystem 128 uses the associated user credential information to authenticate that the user 102 is authorized to access the second executable application 156.

Table 1 illustrates a partial (i.e., abbreviated) example of a structure for the credential translator 130. Table 1 includes a first column identifying executable applications 114, a second column identifying a user identification (ID) for each executable application 114 for the SSO service 126, a third column identifying a user ID for each executable application 114, and a fourth column identifying a password for each executable application 114. In Table 1, the passwords are encrypted for security purposes so they are not readable. For the sake of simplicity, Table 1 does not show other columns, including SSO user password, for example.

TABLE 1

| Executable Application | SSO User ID | Application User ID | Application Password |
|---|---|---|---|
| SSOService | Johndoe12 | Johndoe12 | Xyz123 |
| Clinical_Repository | Johndoe12 | John.doe | GWR864_$ |
| Electronic_Signature | Johndoe12 | JOHNDOE | DH8%TznY |
| PACS | Johndoe12 | Jdoe_5772 | GWR864_$ |
| OutlookEmail | Johndoe12 | John.doe@myco.com | 19283740 |
| PoliciesAndProcedures | Johndoe12 | 483085772 | JohnnyDeer@ |
| . | | | |
| . | | | |
| . | | | |
| SSOService | Janedoe27 | Janedoe27 | Xyz789 |
| OutlookEmail | Janedoe27 | Jane.doe@myco.com | 281054 |
| Patient_Accounts | Janedoe27 | JANE_DOE | Ofiscus1 |
| EIS | Janedoe27 | Jane.doe@myco.com | 281054 |
| Forecasting | Janedoe27 | Doe0ja02 | 281054 |
| PoliciesAndProcedures | Janedoe27 | 478007569 | JanieDear! |
| Etc . . . | | | |

The LDAP subsystem 142 optionally extends the credential translator 130 by allowing user credential information for the executable applications 114 to be stored in a Lightweight Directory Access Protocol (LDAP) directory, instead of the system's repository. LDAP is a standardized networking protocol designed for querying and modifying directory services. The LDAP directory may reside with the system 100 or remote from the system 100.

The request detection agent 132, otherwise called a request detector, provides portal functionality by listening in the background for an executable application 114 to be requested via a URL request. The request detection agent 132 behaves like a web portal without a user interface. Whereas, a web portal responds to user-initiated actions such as mouse clicks, via the data input device 116, on URL links that perform SSO, the request detection agent 132 listens for a special URL that is sent by a requestor application 104. Although the special URLs are triggered by user actions or events in the requestor application 104, the requestor application 104 possesses neither the knowledge of how to process the special URL nor the credentials to access an executable application 114. Hence, the request detection agent 132, in cooperation with the other subsystems 112, translates a special URL message from the requestor (which is not aware of SSO) into one or more commands (including but not limited to a new URL) that can launch an application and perform SSO.

For example, the request detection agent 132 detects a request to access a second executable application 156, such as, for example by identifying a received URL. The request detection agent 132 initiates activation of the credential translator 130 and execution of the second executable application, in response to a detected request and a determination that the user 102 is authorized to access the second executable application 156.

The requester authenticator 134, otherwise called an authenticator processor, authenticates the requestor application 104, as opposed to the user 102, to ensure that the requesting application 104 is recognized as a participant in the system 100. Users register with the SSO service 126 to access the SSO service 126. The requestor application 104 is assigned a unique password (e.g., “Qf987sdfKJHK789098SHmcns9hBVG72634koY . . . ”) to be allowed to request the SSO service 126.

Hence, the system 100 provides two levels of authentication: the authentication subsystem 128 at the first level, and the requestor authenticator 134 at the second level. At the first level of authentication, the SSO service 126 authenticates the user 102, upon initial sign-on. At the second level of authentication, the SSO service 126 verifies that each request comes from a legitimate, requestor application 104 that has been registered with the SSO service 126 by authenticating the application's password. An authenticated requestor application 104 is allowed to send its own user credentials to the SSO service 126, for translation and application launching.

For example, the requestor authenticator 134 and/or the authentication subsystem 128, implemented as an authentication processor, receive the configuration data 138 and the user credential information. The authentication subsystem 128 authenticates a user 102 that is authorized to access a second executable application 156 of the multiple executable applications 114. The authentication subsystem 128 initiates execution of the second executable application 156, in response to a user command to activate the second executable application 156 for a first time during a user session of computer operation. The user command is received at a time occurring within the duration of the user session.

The user command may be received via a display image associated with the second executable application 156, after the user navigates to the display image. The user command may be generated via a link (e.g., a URL link) in the display image. The display image may be associated with a particular task of a task sequence being performed by the user 102 while in another executable application.

The authentication processor uses the credential information 138 provided at the user's logon to the first application 154 to provide automatic user logon to remaining applications of the multiple executable applications 114. The system 100 logs on to an individual application of the remaining applications initiated upon user activation of the individual application of the remaining applications.

To initiate the second executable application 156, the authentication processor employs at least one of the following: a CCOW compatible protocol, UIIP compatible protocol, HTTP Basic protocol, and executable scripts.

The application launcher 136 detects an external request from the requestor application 104, and triggers an application launcher service. The application launcher 136 provides the requestor application 104 with the ability to launch other executable applications 114 from appropriate points in the user's workflow. The application launcher 136 relies on the ability of the requestor application 104 to construct a URL (even if the executable application 114 is not web-based). The application launcher 136 is adaptive enabling launch of an executable application 114, without SSO ability (e.g., in cases where the credentials have not been registered). In these cases, the application launcher 136 displays the sign-on screen for the desired executable application 114 to permit the user 102 to sign on with the appropriate user credential information required by the desired executable application 114.

The memory device 110 represents any type of storage device. The memory device 110 represents one or more memory devices, located at one or more locations, depending on the particular implementation of the system 100. The memory device 110 provides a data store for a database or a file containing application content metadata, such as the configuration data 138 and the mapping information 140.

The configuration data 138 describes for each executable application 114 the following associated information: its location, how it is launched, what SSO method it uses, what parameters it can accept, user credentials required for access, methods of authentication, navigation parameters identifying acceptable application launch points in a user task sequence workflow, and, optionally, the user interface to access it. The metadata also contains, for each executable application 114, an indicator of whether it can be closed automatically (e.g., for single sign-off) when the SSO service 126 is closed.

Additional parameters may be used for searching, for navigation, or other purposes. In one example, it may be desirable to sign in to a medical reference application passing the logon credentials and keyword parameters that automatically construct a search of the reference content database. More specifically, a healthcare provider may be placing a medication order for a patient with a certain diagnosis, and may wish to search the medical reference for journal articles since the year 2003 containing references to that drug and diagnosis. In another example, the parameters may navigate the user deeper into the executable application 114 than would be achieved with SSO alone (e.g., to a specific page). Both examples advantageously provide the user 102 with increased efficiency and convenience. When the executable application 114 does not offer a service interface to accept parameters directly, the system 100 can still send parameters to a script that, in turn, sends the parameters to the executable application 114 to navigate to the appropriate display images (i.e., display screens). The requestor application 104 may also contain a user-friendly name uniquely identifying it to the system 100 (e.g., “CLINICAL_REPOSITORY”).

The mapping information 158 describes for each executable application 114 corresponding executable applications used to launch individual executable application 114.

The session management subsystem 144 keeps track of launched executable applications 114 and their corresponding requestor applications 104. When a requestor application 104 is closed, the launched executable applications 114 may be configured to automatically close. This automatic closing provides security by preventing sensitive Protected Health Information (PHI) from remaining on the user's display screen, if the user has left the display screen but forgot to close the launched executable applications 114. The session management subsystem 144 is generic in that it tracks the launched executable applications 114. However, UIIP-compliant applications have additional activity tracking that is performed through the UIIP subsystem 150.

The scripting subsystem 146 provides access to an executable application 154, for example, that does not support a tighter method of integration, such as the CCOW subsystem 148, the UIIP subsystem 150, or the HTTP subsystem 152. The scripting subsystem 146 provides non-intrusive (i.e., requiring no modification to the executable application 154) access to an executable application 114 by emulating the actions that a user 102 takes to logon.

The CCOW subsystem 148 permits the requestor application 104 to obtain SSO into a CCOW-enabled executable application 156 by placing a User Subject into the CCOW context on behalf of the requester, and relying upon the executable application 156 to respond to the context change. A CCOW context manager may be provided either by a third party, or as another subsystem within the system 100.

The UIIP subsystem 150 permits the requestor application 104 to obtain SSO into a UIIP-enabled executable application 158, for example, by registering encrypted user credentials with a Global Session Manager (GSM) server, for example. The GSM server provides user mappings that the executable application 158 can obtain through a GSM application programming interface (API). The executable application 158, in addition to SSO, includes the benefits of a common session and coordinated session time out.

The HTTP subsystem 152 permits the requestor application 104 to obtain SSO into a web application that uses http basic authentication, by sending the user name and password in a Microsoft-supported format such as, for example, xmlhttp.open (e.g., “GET”, “http://servername/default.asp”, false, “someone”, “mypass”)

The executable applications 114 are typically stored in a memory device. The executable applications 114 may reside within the system 100 or may be remote from the system 100. Individual executable applications 114 correspond to individual subsystems 112, with the exception of the Nth executable application, for explanatory purposes, and are not limited to a number of executable applications per subsystem 112 or in total, and are not limited to the particular application-subsystem correspondence illustrated. Examples of the executable applications 114 include, for example, clinical data repository, eligibility, care protocols, policies and procedures, electronic signature, secure e-mail, and e-prescribing.

An executable application comprises machine code or machine readable instruction for implementing predetermined functions including, for example, those of an operating system, a software application program, a healthcare information system, or other information processing system, for example, in response user command or input. An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters. A calling procedure is a procedure for enabling execution of another procedure in response to a received command or instruction. An object comprises a grouping of data and/or executable instructions or an executable procedure.

As a summary, the system 100 includes one or more of the following features:

1. The system 100 is invoked from the requestor application 104 and extends that application's capabilities to include SSO from appropriate points in that application's user interface, rather than requiring a separate portal user interface. At the same time, it provides a full portal user interface with SSO as well.

2. The system 100 advantageously provides a comprehensive set of SSO capabilities that is broader than web-based, CCOW, or proprietary mechanisms. It is not limited to healthcare applications or applications conforming to any one standard.

3. By providing an XML interface (e.g., from provisioning tools) and an LDAP subsystem 142, the system 100 provides open, standards-compliant methods for identity and authentication management.

4. By providing a credential translator 130 that includes an HL7-compliant interface, the system 100 eliminates the need to maintain a CCOW User Mapper separate from the credential translator 130. The system 100 simplifies the complex task of administering user credential information, such as user identifications (IDs), compared to having to use multiple tools.

5. The strong yet open authentication subsystem 128 and requestor authenticator 134, provides secure SSO preventing a random user or application from logging on and obtaining SSO privileges that are not authorized.

6. The credential translator 130 enables SSO for applications with different user IDs and standards.

7. The LDAP subsystem 142 allows use of centralized policies enabled through the standard technology of an LDAP directory avoiding redundant and possibly inconsistent maintenance of user credentials.

8. The request detection agent 132 supports the provision of SSO capability to requesting applications as a background task, without requiring a user interface.

9. The application launcher 132 with various specialized subsystems 112 enables comprehensive SSO capabilities.

The system 100 does not require the adoption of a separate user interface framework such as portal or a taskbar from which to start applications. Instead, the system 100 enables applications to incorporate the capability within themselves, so that users are not inconvenienced by having to leave their application and go somewhere else to launch another application. Rather, users can launch other applications in the context of their normal workflow.

The system 100 facilitates ease of access to information that a user desires, by lowering the barriers to navigate and sign-in to multiple, different executable applications 114 using different user interfaces. The SSO service 126 and the application launching service provided by the application launcher 136 provide web-based services to launch any application or web link, and to provide single sign-on into one or more executable applications 114, based on previously captured user credential information, without requiring the requestor to know the user credential information. The system 100 may be implemented via a request from a user 102 using a portal user interface (UI) or via a request from any authenticated requestor application 104 that can submit an HTTPS request, including desktop applications. The system 100 makes portal capabilities available in a behind-the-scenes manner from multiple launch points, not just a system entry service.

The system 100 advantageously provides flexibility in how and where users can invoke other executable applications 114, by permitting access either from a portal UI or directly from existing executable applications 114 (i.e., at logical access points within the workflow of an executable application 114), without a portal UI. The system 100 permits non-intrusive reuse of this capability. The result is a streamlined workflow for users 102, reduced administrative effort for information technology staff, and reduced cost of development for providers and developers of the executable applications 114.

In the system 100, a user 102 logs in once to a first application 154, and if logon is successful, upon initiating activation of a second application 156 at some subsequent time, the system 100 accesses configuration data 138 to obtain automatic logon and authentication information for the user to initiate the second application 156. Further, a user 102 may initiate at another subsequent time, a third application 158, via button selection, for example, in a display image associated with the second application 156 or the first application 154, for example, resulting in access to the third application 158, via the configuration data 138.

In contrast to the known system disclosed in U.S. Pat. No. 5,774,551, a user of the present system 100 logs in once to a first application. Responsive to a successful logon by the user 102 to the first application, the present system 100 causes automatic access to configuration data 138 to obtain automatic logon and authentication information for multiple predetermined additional executable applications 114 determined by the configuration data 138.

In the known system disclosed in U.S. Pat. No. 5,774,551, a user cannot initiate subsequent access to another non-predetermined application that is not originally initiated following logon to the first application, without a new logon being required. The known system disclosed in U.S. Pat. No. 5,774,551 automatically initiates access to a predetermined group of applications following successful logon to a first application. The known system disclosed in U.S. Pat. No. 5,774,551 initiates access from any “system entry service” to multiple account management services on a computer system. The known system disclosed in U.S. Pat. No. 5,774,551 does not describe SSO being possible from anywhere other than the system entry service.

In contrast, the present system 100 permits access to application launching and SSO capabilities to be from any requesting application. Whereas the known system disclosed in U.S. Pat. No. 5,774,551 initiates access from any “system entry service” to connect the user to the computer system (e.g. upon logon to the computer through Windows/Unix, ftp, or Telnet), multiple predetermined secondary authentications are automatically invoked from a configuration file. The present system 100 is more efficient for the user, the computer, and the network, because the present system 100 launches desired executable applications 114 when needed, as opposed to the known system disclosed in U.S. Pat. No. 5,774,551 automatically initiating access from a system entry service to predetermined applications at the same time.

The system 100 provides the following advantages, for example.

1. The system 100 is lightweight in that it does not require software to be installed on each user's device. The system 100 is simple to invoke via Hypertext Transport Protocol (http), which is readily available. The system 100 uses the http protocol for communication, even though it can launch non-http-based applications. The use of a Uniform Resource Locator (URL) means that it is not necessary for any other application to know the physical location of the SSO service, just its name.

2. The system 100 is open-ended in terms of what executable applications 114 it can launch. The system 100 is not limited to web-based applications or any particular technology.

3. The system 100 offers more than generic SSO services by supporting healthcare standards (e.g., HL7 CCOW) and proprietary protocols (e.g., UIIP/GSM) where they are used, thereby reducing the need for scripting.

4. The system 100 supports access to a much broader variety of executable applications 114 than HL7 CCOW alone.

5. The system 100 does not require significant development from executable applications 114 requesting its services.

6. The system 100 may be implemented with a web portal user interface provided along with the system 100, another web portal provided by a customer of the system 100 (since it is assumed that web portals provide the ability to construct and launch URLs), or a customer's home-grown, web-based user interface.

7. The system 100 is a non-intrusive black box that lists input data, response, and exception conditions in its public interface.

8. The system 100 can be invoked from any executable application as needed, not just from a system entry service. Thus, the system 100 may be implemented more naturally into the user's normal workflow and does not automatically log in to any application unnecessarily.

9. The system 100 transmits authentication credentials and contextual information to seamlessly launch executable applications.

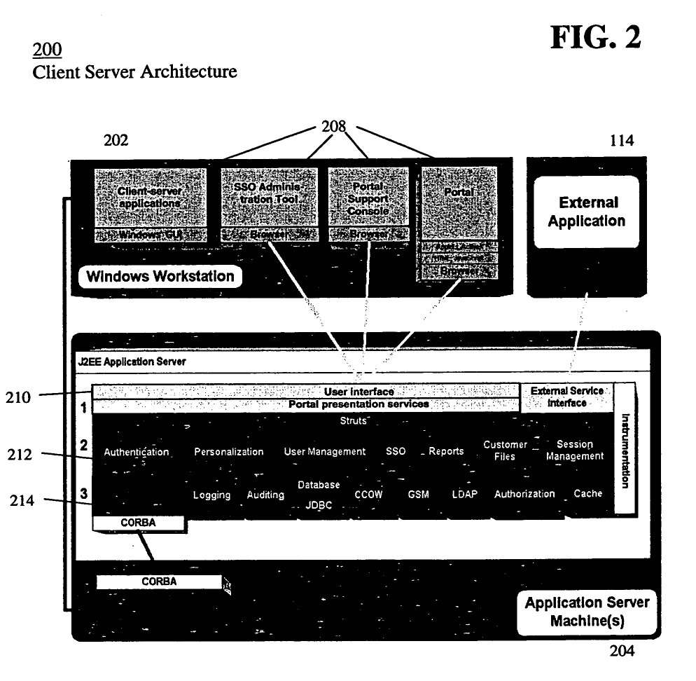

FIG. 2 illustrates an example of a client-server architecture 200 for the system 100, as shown in FIG. 1. The architecture 200 includes a client device 202, a server device 204, and an external application 114.

The client device 202 further includes a user interface 208 including a web browser (e.g., for a SSO administration tool), a browser (e.g., for a portal and an SSO support console), and a graphical user interface (e.g., Windows) for non-web-based client-server applications.

The server device 204 further includes, for example, a user interface layer 210, business logic layer 212, and services layer 214.

The user interface layer 210 further includes a user interface, portal presentation services to display portal specific elements (e.g., header, pages, frames, and links), and an external service interface. The user interface presentation 210 contains the components responsible for delivering the user interface to the client device 202.

The business logic layer 212 further includes, for example, authentication, personalization, user management, SSO, reports, customer files, and session management. The components of the business logic layer 212 are implemented, for example, in a combination of Java objects, Java Beans, and possibly EJBs. SSO is the primary component in the business logic 212.

The services layer 214 further includes, for example, a portal API (using object-based technologies, e.g., CORBA), logging, auditing, a database, CCOW, GSM, LDAP, authorization, and cache. The services layer 214 contains components and services that are either provided by third parties, or are not core to the business logic layer 212. The services layer 214 provides lower-level common services and/or interface with other servers.

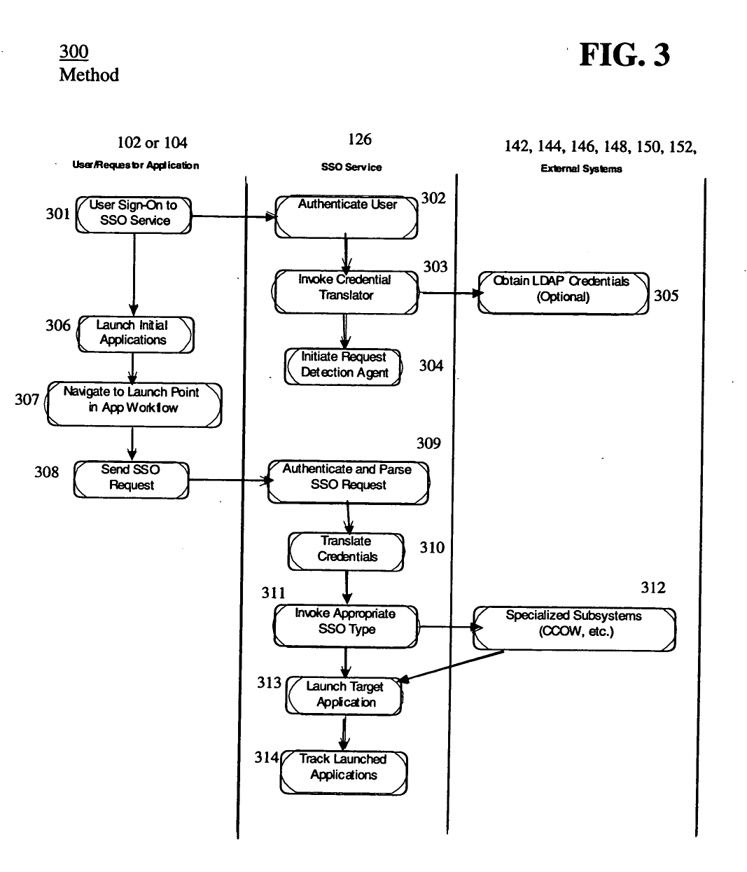

FIG. 3 illustrates a method 300 for the system 100, as shown in FIG. 1. The method 300 illustrates a typical end-user run-time workflow in which the system 100 participates.

In most real-world situations, there is a diversity of executable applications from different vendors, some legacy, some modern, without centralized or consistent management of user credentials across the executable applications. Although one executable application 114 is necessary to illustrate the structural and operational aspects of the system 100, multiple executable applications 114 are mentioned because the magnitude and diversity of real-life access challenges is what magnifies the advantages of the system 100.

At step 301, the user 102 signs on to the SSO service 126 directly or via a portal, which invokes the SSO service 126. The SSO service 126 may also be started in the background, if used simply as a service without a user interface. The portal includes a front-end interface, such as an XML interface from a trusted authentication source such as biometrics or smart card integrated with Windows logon, such that it starts automatically without the user being conscious of it starting. This initial sign-on establishes the user's SSO user ID, which can deemed a common thread that associates the application user IDs with the same logical user.

At step 302, the authentication subsystem 128 authenticates the user 102.

At step 303, upon the user's first sign-on, the SSO service 126 invokes the credential translator 130, which creates credential translation tables for that particular user (e.g., for each executable application 114, a user ID, a password, as shown in Table 1). The tables are created in memory or on storage devices, and are available instantly on demand, whenever any of the executable applications 114 may be launched.

At step 304, the SSO service 106 initiates the request detection agent 132, which runs in the background and listens for subsequent requests from requestor applications 104. Unless a request to start an executable application 114 is made by a requestor application 104, the request detection agent 132 is not noticeable to the user.

At step 305, the credential translator 130, optionally, obtains user credential information from a LDAP directory, via the LDAP subsystem 142. Step 305 applies if LDAP has been designated as a master repository of user credential information; otherwise, credentials are obtained from the SSO service's internal user repository.

At step 306, the system 100 launches the initial executable applications responsive to the user 102 signing onto the SSO service 126

At step 307, the user 102 navigates to a place in the workflow of a requestor application 104 that permits launching another executable application 114 with SSO, such as via a URL link. Optionally, parameters from the requestor application 104 may be included in the context. For example, in a Physician Order Entry application, the user navigates to a place where he is ready to write a medication e-prescription, and clicks on an URL associated with an executable application that supports writing and transmitting medication e-prescriptions.

At step 308, the requestor application 104 sends SSO launch requests intended for executable applications 114. The requestor application 104 does not communicate directly point-to-point with the executable applications 114, but instead communicates with the SSO service 126, which is used to fill in the missing details. Examples of executable applications 114 providing functions including one or more of the following:

Search of reference material driven by diagnosis and/or ordering parameters (e.g., NDC code sent to search a drug database, ICD-9 code sent to an evidence-based medicine database). These parameters are sent in addition to user credentials, for in-context searching.

CCOW-based SSO, such as, for example, into an electronic signature application (including user and patient context)

HTTP basic authentication for SSO, such as, for example, into a secure e-mail application, to communicate protected health information to a consulting physician.

Scripted SSO, such as, for example, into a policies and procedures application.

Non-CCOW launched, such as, for example, into Patient Electronic Medical Record, sending patient context via encrypted URL (e.g., UIIP)

At step 309, upon detecting an SSO request, the request detection agent 132 invokes the requestor authenticator 134, which verifies that the request is coming from a legitimate (i.e., registered) requestor application 104, and not a hacker or unauthorized application. The requestor authenticator 134 authenticates the SSO requestor application 104 (not the user 102), and maps the user parameters into appropriate syntax (e.g., URL query string parameters, script input parameters, CCOW message, etc.)

At step 310, the application launcher 132 accesses the credential translation table, shown by example herein in Table 1, to determine the credentials and other SSO data for the executable application 114, in response to receiving an authenticated request, and a combination of SSO user ID, application user ID and an application code, for example. The application launcher 132 also accesses the configuration data 138 for SSO type and other specific instructions on how to launch and sign on to the executable applications 114.

At step 311, the application launcher 136 invokes the appropriate subsystem 112 (i.e., CCOW 148, UIIP 150, script 146, or HTTP 152) depending on the type of SSO required, passing it the credentials and other SSO data for the executable application 114.

At step 312, the appropriate subsystem 112 is notified of information necessary to pass user context, but relies upon the application launcher 136 to start the corresponding executable application 114 by generating the URL or command line string. However, for scripting, the application launcher 132 does not directly start the corresponding executable application 114. The application launcher 132 simply launches the script, which starts the corresponding executable application 114 and sends the necessary commands/keystrokes.

At step 313, a subsystem 112 launches the appropriate corresponding executable application 114.

At step 314, the session management subsystem 144 records each executable application 114 launched by the application launcher 132, so that the launched executable applications 114 can be automatically closed upon the termination of the SSO service 126, for security and privacy reasons.

A user 102 quits the system 100, either by closing or logging off the portal or the SSO service 126, or by an inactivity timeout. At this time, launched executable applications 114 are closed, if configured to do so.

Hence, while the present invention has been described with reference to various illustrative embodiments thereof, the present invention is not intended to be limited to these specific embodiments. Those skilled in the art will recognize that variations, modifications, and combinations of the disclosed subject matter can be made without departing from the spirit and scope of the invention as set forth in the appended claims.

What is claimed is:

1. A system for enabling a user to access a plurality of operating executable applications, comprising:
a source of configuration data for a plurality of executable applications, said configuration data identifying, an individual executable application and how said individual executable application is launched;
an interface processor for receiving user credential information including a user identifier in response to user initiation of a first executable application of said plurality of executable applications; and
an authentication processor, using said configuration data and received user credential information for,
authenticating a user is authorized to access a second executable application of said plurality of executable applications and
initiating execution of said second executable application, in response to a user command to activate said second executable application for a first time during a user session of computer operation.

2. A system according to claim 1, wherein
said user credential information is received in response to user logon to said first executable application and
said authentication processor uses said credential information provided to logon to said first application to provide automatic user logon to remaining applications of said plurality of executable applications and logon to an individual application of said remaining applications is initiated upon user activation of said individual application of said remaining applications.

3. A system according to claim 1, wherein
said configuration data identifies a location of said individual executable application and user credentials required to access said individual application.

4. A system according to claim 1, including
a credential translator for converting user credential information received by said interface processor to be compatible with credential information required to access said second executable application and
said authentication processor, uses said converted credentials to authenticate said user is authorized to access said second executable application.

5. A system according to claim 4, including
a request detector for detecting a request to access said second executable application and initiating activation of said credential translator and execution of said second executable application in response to a detected request and a determination said user is authorized to access said second executable application wherein
said request detector detects said request to access said second executable application by identifying a received URL.

6. A system according to claim 4, wherein
said credential translator determines credentials required to access said second executable application from said configuration data.

7. A system according to claim 1, wherein
said configuration data identifies methods of authentication of individual applications of said plurality of executable applications,
said authentication processor authenticates a user is authorized to access said second executable application using a method of authentication determined using said configuration data and
said authentication processor employs at least one of, (a) a CCOW compatible protocol, (b) UIIP compatible protocol, (c) HTTP Basic protocol, and executable Scripts, in initiating said second executable application.

8. A system according to claim 1, wherein
said configuration data identifies navigation parameters identifying acceptable application launch points in a user task sequence workflow and said user credential information includes at least one of, (a) a password associated with said user identifier, and (b) a trust token.

9. A system according to claim 1, including
mapping information identifying for individual executable applications corresponding executable applications used to launch said individual applications and
a logoff processor for, in response to a received command to close a particular executable application, using said mapping information to selectively close,
(a) said particular executable application and
(b) executable applications exclusively launched from said particular executable application.

10. A system for enabling a user to access a plurality of operating executable applications with a single logon, comprising:
a source of configuration data for a plurality of executable applications, said configuration data identifying, an individual executable application and how said individual executable application is launched;
an interface processor for receiving user credential information including a user identifier in response to user logon to a first executable application of said plurality of executable applications; and
an authentication processor, using said configuration data and received user credential information for providing automatic user logon to remaining applications of said plurality of executable applications and logon to an individual application of said remaining applications is initiated upon user first activation of said individual application of said remaining applications during a user session of computer operation at a time occurring within the duration of said session.

11. A system for enabling a user to access a plurality of operating executable applications with a single logon, comprising:
a source of configuration data for a plurality of executable applications, said configuration data identifying, an individual executable application and how said individual executable application is launched;
an interface processor for receiving user credential information including a user identifier in response to user initiation of a first executable application of said plurality of executable applications; and
an authentication processor, using said configuration data and received user credential information for,
authenticating a user is authorized to access a second executable application of said plurality of executable applications and
initiating execution of said second executable application, in response to a user command to activate said second executable application received via an image associated with said second executable application following user navigation to said image.

12. A system according to claim 11, wherein
said authentication processor initiates execution of said second executable application, in response to a user command to activate said second executable application via a link associated with said second executable application following user navigation to said image.

13. A system according to claim 11, wherein
said image is associated with a particular task of a task sequence being performed by said user and
said user command to activate said second executable application is for a first activation of said second executable application during a user session of computer operation, said command being received at a time occurring within the duration of said session.

14. A method comprising:
receiving, from a user, user credential information in response to user initiation of a first executable application of a plurality of executable applications;
authenticating that the user is authorized to access the first executable application responsive to receiving the user credential information;
launching the first executable application responsive to authenticating that the user is authorized to access the first executable application;
receiving a request to launch a second executable application responsive to an input from the user into the first executable application;
authenticating that the user is authorized to access the second executable application of said plurality of executable applications responsive to receiving the request to launch the second executable application, and responsive to a source of configuration data identifying the second executable application and launching conditions for the second executable application; and
launching the second executable application responsive to authenticating that the user is authorized to access the second executable application.

15. The method according to claim 14, further comprising:
tracking the launch of the first and second applications; and
closing at least one of the first and second applications responsive to predetermined conditions.
